(19) United States
(12) Patent Application Publication
(10) Pub. No.: US 2026/0141454 A1
(43) Pub. Date: May 21, 2026

(54) COMPUTER METHOD AND SYSTEM FOR APPLYING GENERATIVE ARTIFICIAL INTELLIGENCE TO INSURANCE DATA

(71) Applicant: Sedgwick Claims Management Services, Inc., Memphis, TN (US)

(72) Inventors: Leah Cooper, Chattanooga, TN (US); Josh Friedl, Memphis, TN (US); Timothy Crosas, Collierville, TN (US); Daniel Schweizer, Memphis, TN (US); Timothy Brownawell, Bartlett, TN (US)

(73) Assignee: Sedgwick Claims Management Services, Inc., Memphis, TN (US)

(21) Appl. No.: 18/949,231

(22) Filed: Nov. 15, 2024

(51) Int. Cl. G06Q 40/08

(52) U.S. Cl. CPC G06Q 40/08

(57) ABSTRACT

A computer-implemented method and system for generating Artificial Intelligence (AI) content for insurance claim data for processing an insurance claim in an insurance claims computer application. Insurance claim data is captured from an insurance company and analyzed by one or more AI techniques. One or more prompts are generated indicating one or more AI models to be used in conjunction with captured insurance claim data. The captured insurance claim data is digitized so as to be processed by at least one generative AI system using the one or more prompts via an application programming interface (API) call. AI content is generated by generative AI system responsive to the one or more prompts and associated digitized captured insurance claims data. The generated AI content is transmitted to the insurance claim computer application for use in subsequent insurance claims processing procedures.

### CROSS REFERENCE TO RELATED APPLICATIONS

This application claims priority to U.S. patent application Ser. No. 63/575,167 filed Jun. 6, 2024 which is incorporated herein by reference in its entirety.

### BACKGROUND

### 1. Field

Artificial Intelligence (AI) based system and process for analyzing insurance related information and data, and more particularly to utilizing generative AI techniques to extract, summarize, and analyze data in an automated workflow.

### 2. Description of Related Art

Currently, insurance claim examiners expend significant time and effort reviewing voluminous documentation, and other information (e.g., photographs) relating to an insurance claim submission. There is currently a need to provide an automated system and process that rapidly, and intelligently, analyzes documentation and other data types relating to an insurance claim submission for rapidly providing valuable and insightful information relating to an insurance claim. Thus, AI analytical techniques are increasingly essential in determining and processing insurance claims due to their ability to enhance efficiency, accuracy, and decision-making. Traditional methods often involve manual processing and subjective judgments, which can lead to delays, errors, and inconsistencies. Thus, exists a need to integrate existing systems that process insurance claims with AI technology.

In accordance with the illustrated embodiments described herein, the integration of AI technology into existing insurance claim processing systems provides the following advantages and improvements, including automation of routine tasks, in which AI can automate repetitive and time-consuming tasks, such as data entry and initial claim assessments, freeing up human resources for more complex tasks and reducing operational costs. AI will further provide fraud detection by analyzing large volumes of data to detect anomalies and patterns indicative of fraudulent claims. By identifying suspicious activities early, AI helps in mitigating risks and preventing losses. Additionally, AI provides improved accuracy in analysis of insurance data as it will utilize machine learning (ML) models the analyze historical claim data to make more accurate predictions and assessments. This reduces the risk of human error and ensures more consistent and objective decisions. AI will additionally provide improvements in data insights by using predictive analytic techniques to, for instance, uncover trends and insights from claim data, aiding in better risk management and the development of targeted insurance products, as well as streamline claims processing by integrating various data sources and apply complex algorithms to process claims more swiftly, resulting in quicker resolutions and improved operational efficiency.

In summary, AI analytical techniques in insurance claims processing are crucial for modernizing insurance claims processing by automating tasks, improving accuracy, detecting fraud, enhancing customer experience, and providing valuable data insights.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings. To achieve these and other advantages, and in accordance with the purpose of the illustrated embodiments, in one aspect, described is a computer-implemented method and process that utilizes generative AI techniques to preferably extract, summarize, and analyze data in an insurance claims related workflow by digitizing insurance data for subsequent AI/ML processing in generative AI systems. In an illustrated embodiment, insurance related claims data is provided from a legacy computer system, preferably associated with an insurance company (which may include one or more imaging systems) into a novel AI digitization system, preferably via a secure Application Programming Interface (API). The AI digitization system is preferably configured and operative to analyze the data in the insurance claims workflow (insurance data workflow) to determine an appropriate API call and a set of prompts is to be associated with the insurance data workflow for subsequent application with a generative AI system.

In certain illustrated embodiments, the AI digitization system is configured and operative to digitize the insurance data workflow using one or more suitable data digitization techniques, such as (but not limited to), Microsoft Azure's Document Intelligence Tools. Once the insurance data workflow is digitized in the AI digitization system, the digital content is then transmitted to, preferably along with its determined API call and one or more prompts, to one or more generative AI systems, such as (but not limited to) ChatGPT. Typically, in a near real-time basis, the one or more generative AI systems generate responses (summarized content) responsive to input of the aforesaid digital content (along with it associated determined API call and one or more prompts). This AI summarized content is then transmitted back to the AI digitization system. The AI digitization system is then operative and configured to transmit the AI summarized content back to the insurance claims processing system for subsequent processing/analysis.

In certain illustrated embodiments, the AI summarized content may be recorded as a note in the insurance claims processing system, which for instance, may be used by an insurance claims examiner for facilitating one or more determinations for an insurance claim relating to insurance data included in the aforesaid insurance data workflow. Thus, a significant advantage provided by the AI digitization system is it enables user's (e.g., insurance claim examiners) to explore the impact of generative AI performance and natural language processing on day-to-day tasks, such as document summarization, claims queries, medical and biomedical classifications, etc. It is to be appreciated and understood that automating important, but often routine aspects, of an insurance claims workflow processes, with generative AI techniques rapidly (and preferably on an automated basis) provides significant insightful information to user's (e.g., insurance claim examiners) of an insurance claims processing system regarding one or more determinations to be made, such as, formulating insurance claim determination decisions.

For instance, the AI digitization system allows insurance claim adjusters/examiners, with “the touch of a button,” to generate summaries of scanned documents rapidly and automatically to add highlights to appropriate files in an insurance claims processing system. In certain illustrated embodiments, the AI digitization system automatically identifies (via one or more generative AI techniques) key data for significantly assisting insurance claim adjusters/examiners with completing tasks and rendering meaningful decision-making impact on insurance claim determinations. The AI digitization system provides digitization of relevant insurance claims related data for exposing key insights and driving prescriptive recommendations for insurance claims examiners/adjusters in their decision-making processes. For instance, the AI digitization system is operative and configured to provide automated summaries of scanned documents nearly instantaneously for providing relevant highlights to appropriate claim files.

Thus, the illustrated embodiments provide a technology improvement to exiting insurance claims computer processing systems through integration with AI analytical techniques for modernizing/improving insurance claims processing by automating tasks, improving accuracy, detecting fraud, enhancing customer experience, and providing valuable data insights.

### BRIEF DESCRIPTION OF THE DRAWINGS

So that those skilled in the art to which the subject disclosure appertains will readily understand how to make and use the devices and methods of the subject disclosure without undue experimentation, preferred illustrated embodiments thereof will be described in detail herein below with reference to certain figures, wherein:

FIG. 1 illustrates an example communication network utilized with one or more of the illustrated embodiments;

FIG. 2 illustrates an example network device/node utilized with one or more of the illustrated embodiments;

FIG. 3 illustrates a diagram depicting an Artificial Intelligence (AI) device utilized with one or more of the illustrated embodiments;

FIG. 4 illustrates a diagram depicting an AI server utilized with one or more of the illustrated embodiments;

FIG. 5 illustrates a simplified system level diagram of certain illustrated embodiments; and

FIG. 6 is a flowchart a method of operation in accordance with one or more of the illustrated embodiments.

### DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this illustrated embodiment belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

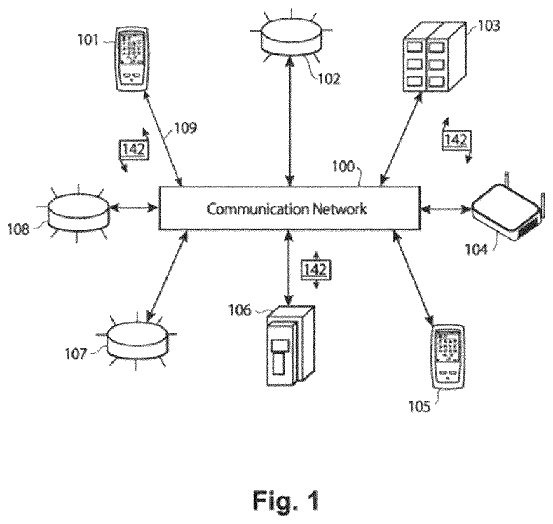

Turning now descriptively to the drawings, in which similar reference characters denote similar elements throughout the several views, FIG. 1 depicts an exemplary communications network 100 in which below illustrated embodiments may be implemented. It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively comprising nodes/devices 101-108 (e.g., sensors 102, computing devices 103, smart phone devices 105, web servers/computer systems 106, computer systems 107, switches 108, databases, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the illustrated embodiments may be embodied as a system, method or computer program product. Accordingly, aspects of the illustrated embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the illustrated embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the illustrated embodiments may be written in any combination of one or more programming languages, including an object oriented programming language such as Python, Golang, Ruby, ASP. NET, Java,, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the illustrated embodiments are described below with reference to flowchart illustrations and/or block diagrams of methods, apparatus (systems) and computer program products according to the illustrated embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

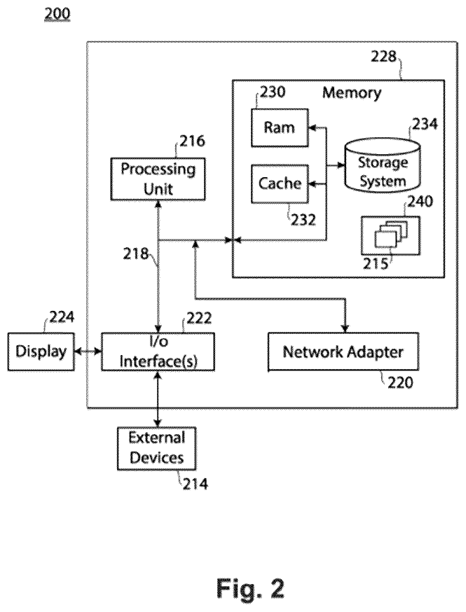

FIG. 2 is a schematic block diagram of an example network computing device 200 (e.g., computing device/system (insurance claims processing system) 103, computer system (AI digitization system) 106, etc.) that may be used (or components thereof) with one or more embodiments described herein, e.g., as one of the nodes shown in the network 100. As explained above, in different embodiments these various devices are configured to communicate with each other in any suitable way, such as, for example, via communication network 100.

Device 200 is intended to represent any type of computer system capable of carrying out the teachings of various illustrated embodiments. Device 200 is only one example of a suitable system and is not intended to suggest any limitation as to the scope of use or functionality of the illustrated embodiments described herein. Regardless, computing device 200 is capable of being implemented and/or performing any of the functionality set forth herein, including an insurance claims computer system 103, AI digitization system 103, and generative AI system 107, in accordance with the illustrated embodiments.

Computing device 200 is operational with numerous other general purpose or special purpose computing system environments or configurations. Examples of well-known computing systems, environments, and/or configurations that may be suitable for use with computing device 200 include, but are not limited to, cloud computing systems (including, but not limited to:
Infrastructure as a Service (Iaas); Software as a Service (Saas); Platform as a Service (PaaS);
and Private cloud), personal computer systems, server computer systems, thin clients, thick clients, hand-held or laptop devices, multiprocessor systems, microprocessor-based systems, programmable consumer electronics, network PCs, minicomputer systems, and distributed data processing environments that include any of the above systems or devices, and the like. Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices. In accordance with the illustrated embodiments, computing device 200 is configured and operative, relative to AI digitization system 106, to utilize generative AI techniques to preferably extract, summarize, and analyze data in an insurance claims related workflow by digitizing insurance data for subsequent AI/ML processing in generative AI systems (107).

The components of device 200 may include, but are not limited to, one or more processors or processing units 216, a system memory 228, and a bus 218 that couples various system components including system memory 228 to processor 216. Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of illustrated embodiments.

Program/utility 240, having a set (at least one) of program modules 215, such as underwriting module, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of the illustrated embodiments as described herein, including, but not limited to utilizing generative AI techniques to preferably extract, summarize, and analyze data in an insurance claims related workflow, by digitizing insurance data for subsequent AI/ML processing in generative AI systems (107), as described further below.

Device 200 may also communicate with one or more external devices 214 such as a keyboard, a pointing device, a display 224, etc. ; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: big data technologies encompassing large and diverse datasets that are significant in volume, which are commonly used in machine learning, predictive modeling, and other advanced analytics to solve business problems and make informed decisions; non-relational databases (NoSQLs); Blob storage; relational databases (SQL); as well as microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which the below described illustrated embodiments may be implemented. FIGS. 1 and 2 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

It is to be understood the embodiments described herein are preferably provided with self-learning/Artificial Intelligence (AI) to utilize generative AI techniques to preferably extract, summarize, and analyze data in an insurance claims related workflow, preferably provided by an insurance claims system 103, by digitizing insurance data for subsequent AI/ML processing in generative AI systems (107), as described further below. Thus, preferably integrated into an AI digitization system (106) coupled to one or more insurance claims processing systems (103) is an AI compatible system (e.g., an Expert System) that implements machine learning and artificial intelligence algorithms to conduct one or more of the above mentioned insurance related digitization modelling tasks, preferably on an automated basis using one or more generative AI techniques. For instance, the AI system may include two subsystems: a first sub-system that learns from historical data; and a second subsystem to identify and recommend one or more parameters or approaches based on the learning. It should be appreciated that although the AI system may be described as two distinct subsystems, the AI system can also be implemented as a single system incorporating the functions and features described with respect to both subsystems. In accordance with the illustrated embodiments described herein, artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

Also in accordance with the illustrated embodiments, an artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value. The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function. The purpose of the learning of the artificial neural network may be to determine the model parameters that minimize a loss function. The loss function may be used as an index to determine optimal model parameters in the learning process of the artificial neural network. Machine learning may be classified into supervised learning, unsupervised learning, and reinforcement learning according to a learning method. The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

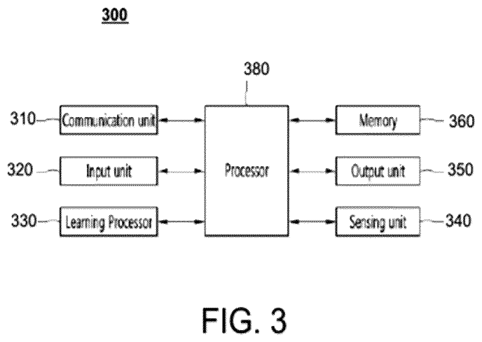

Machine learning, which is implemented as a deep neural network (DNN) including a plurality of hidden layers among artificial neural networks, is also referred to as deep learning, and the deep learning is part of machine learning. FIG. 3 illustrates an AI device 300 according to an illustrated embodiment. In accordance with the illustrated embodiments, the AI device 300 may be integrated into in an AI digitization system 106, for certain tasks, such as prompt generation (as further described below).

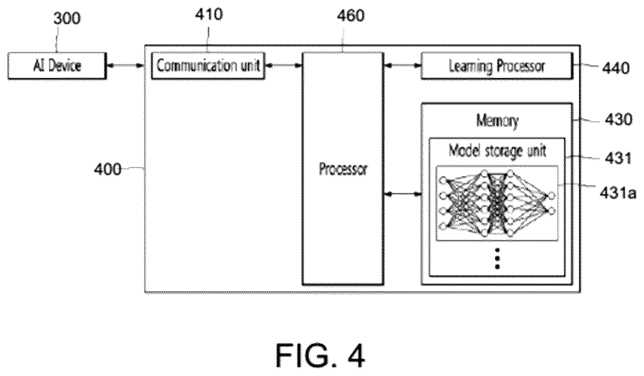

Referring now FIG. 3, in conjunction with FIGS. 1 and 2, the AI device 300 is operatively coupled to, or integrated with computing device 200, in accordance with the illustrated embodiments described herein. AI device 300 preferably includes a communication unit 310, an input unit 320, a learning processor 330, a sensing unit 340, an output unit 350, a memory 370, and a processor 380. The communication unit 310 may transmit and receive data to and from external devices such as other AI devices 300a to 300e and an AI server 400 (FIG. 4) by using wire/wireless communication technology. For example, the communication unit 310 may transmit and receive sensor information, a user input, a learning model, and a control signal to and from external devices.

The communication technology used by the communication unit 310 preferably includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 320 may acquire various kinds of data, including, but not limited to insurance claims data and data relating to insured clients. The input unit 320 may acquire a learning data for model learning and an input data to be used when an output is acquired by using learning model. The input unit 320 may acquire raw input data. In this case, the processor 380 or the learning processor 330 may extract an input feature by preprocessing the input data. The learning processor 330 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 330 may perform AI processing together with the learning processor 330 of the AI server 400, and the learning processor 330 may include a memory integrated or implemented in the AI device 300. Alternatively, the learning processor 330 may be implemented by using the memory 370, an external memory directly connected to the AI device 300, or a memory held in an external device. The sensing unit 340 may acquire at least one of internal information about the AI device 300, ambient environment information about the AI device 300, and user information by using various sensors.

The output unit 350 preferably includes a display unit for outputting/displaying relevant information to a user in accordance with the illustrated embodiments described herein. The memory 370 preferably stores data that supports various functions of the AI device 300. For example, the memory 370 may store input data acquired by the input unit 320, learning data, a learning model, a learning history, and the like.

The processor 380 preferably determines at least one executable operation of the AI device 300 based on information determined or generated by using a data analysis algorithm or a machine learning algorithm. The processor 380 may control the components of the AI device 300 to execute the determined operation. To this end, the processor 380 may request, search, receive, or utilize data of the learning processor 330 or the memory 370. The processor 380 may control the components of the AI device 300 to execute the predicted operation or the operation determined to be desirable among the at least one executable operation. When the connection of an external device is required to perform a determined operation, the processor 380 may generate a control signal for controlling the external device and may transmit the generated control signal to the external device. The processor 380 may acquire intention information for the user input and may determine the user's requirements based on the acquired intention information. The processor 380 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 330, may be learned by the learning processor 340 of the AI server 400, or may be learned by their distributed processing. The processor 380 may collect history information including the operation contents of the AI device 300 or the user's feedback on the operation and may store the collected history information in the memory 370 or the learning processor 330 or transmit the collected history information to the external device such as the AI server 400. The collected history information may be used to update the learning model.

The processor 380 may control at least part of the components of AI device 300 so as to drive an application program stored in memory 370. Furthermore, the processor 380 may operate two or more of the components included in the AI device 300 in combination so as to drive the application program.

FIG. 4 illustrates an AI server 400 according to the illustrated embodiments. It is to be appreciated that the AI server 400 may refer to a device that learns an artificial neural network by using a machine learning algorithm or uses a learned artificial neural network. The AI server 400 may include a plurality of servers to perform distributed processing or may be defined as a 5G network. At this time, the AI server 400 may be included as a partial configuration of the AI device 300 and may perform at least part of the AI processing together. The AI server 400 may include a communication unit 410, a memory 430, a learning processor 440, a processor 460, and the like. The communication unit 410 can transmit and receive data to and from an external device such as the AI device 300. The memory 430 may include a model storage unit 431. The model storage unit 431 may store a learning or learned model (or an artificial neural network 431a) through the learning processor 440.

The learning processor 440 may learn the artificial neural network 431a by using the learning data. The learning model may be used in a state of being mounted on the AI server 400 of the artificial neural network or may be used in a state of being mounted on an external device such as the AI device 300. The learning model may be implemented in hardware, software, or a combination of hardware and software. If all or part of the learning models are implemented in software, one or more instructions that constitute the learning model may be stored in memory 430. The processor 460 may infer the result value for new input data by using the learning model and may generate a response or a control command based on the inferred result value.

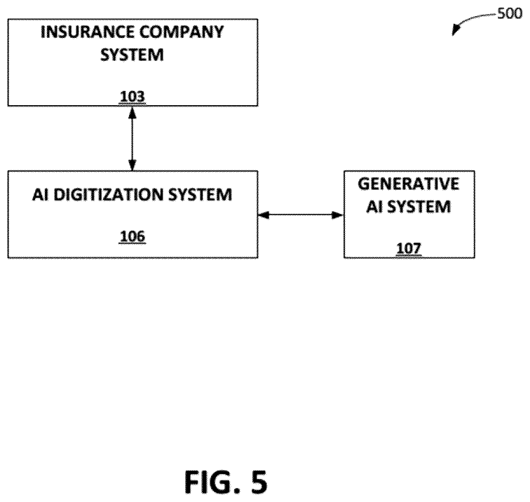

With the exemplary communication network 100 (FIG. 1), computing device 200 (FIG. 2), AI device 300 (FIG. 3) and AI server 400 (FIG. 4) being generally shown and discussed above, description of certain illustrated embodiments will now be provided with below reference to FIG. 5. It is to be understood and appreciated that FIGS. 1-4 are intended to provide a brief, general description of an illustrative and/or suitable exemplary environment in which the below described illustrated embodiments may be implemented. FIGS. 1-4 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

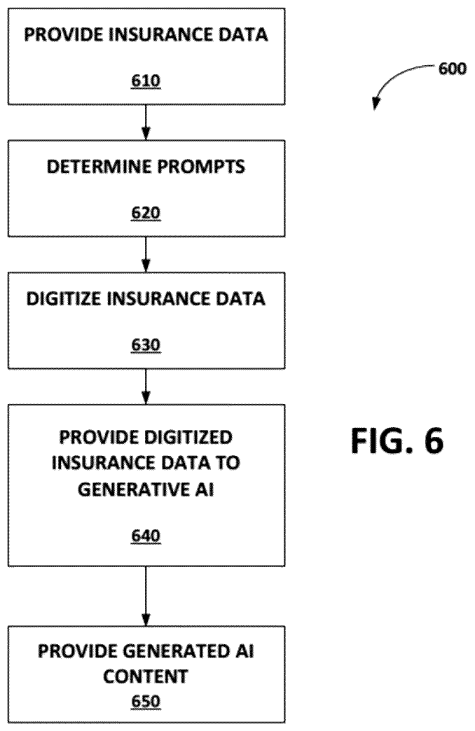

With reference now to FIG. 5 (and with continuing reference to FIGS. 1-4), shown is an exemplary generalized system 500, utilizing one or more of the aforementioned communication network 100 (FIG. 1), computing device 200 (FIG. 2), AI device 300 (FIG. 3) and AI server 400 (FIG. 4), depicting one or more illustrated embodiments that utilize generative AI techniques to preferably extract, summarize, and analyze data in an insurance claims related workflow by digitizing insurance data for subsequent AI/ML processing in generative AI systems, as described further below with reference to process 600 of FIG. 6.

In accordance with the illustrated embodiments, system 500 preferably includes an insurance claims processing system 103 (which may be a legacy system) operatively coupled to an AI digitization system 106 (e.g., a computer server), which is communicatively coupled to a generative AI system 107. In accordance with the illustrated embodiments, the generative AI system 107 is to be understood to encompass a type of artificial intelligence that can create new content like text, images, audio, videos, and synthetic data. Generative AI models may use neural networks to find patterns and structures in existing data (e.g., digitized insurance claims data) to generate new content. For example, natural language processing (NLP) techniques can turn characters into sentences, parts of speech, entities, and actions. In accordance with the illustrated embodiments, AI NLP (Natural Language Processing) refers to the field of artificial intelligence that focuses on the interaction between computers and human language. It includes algorithms and models that enable computers (e.g., digitization system 106, and generative AI system 107) to understand, interpret, and generate human language in a way that is both meaningful and useful. AI NLP as implemented by the below described AI digitization system 106, includes automated documents translation services using AI techniques such as: machine learning, deep learning, and computational linguistics. For instance, the illustrated AI digitization system 106, uses AI techniques to perform one or more of: a) text processing techniques for processing and manipulating text, such as tokenization (breaking down text into words or phrases), stemming, and lemmatization (reducing words to their base or root form); b) language modeling models for predicting the likelihood of a sequence of words (e.g, for use in tasks such as text generation, machine translation, and speech recognition); c) sentiment analysis for determining the sentiment or emotion expressed in a piece of text, such as whether a review is positive or negative; d) named entity recognition (NER) for identifying and classifying key elements in text into predefined categories such as names of people, organizations, locations, etc.; e) machine translation for automatically translating text from one language to another; f) speech recognition and generation for converting spoken language into text (speech recognition) and vice versa (speech generation or text-to-speech); and g) information retrieval and extraction tasks for searching large volumes of text to find relevant information or extracting specific data points from text.

For example, such a generative AI model may be ChatGPT (Chat Generative Pre-trained Transformer) which is a chatbot that uses natural language processing (NLP) and generative AI techniques to provide human-like conversations (via AI summarized content). In accordance with the illustrated embodiments, based upon analysis of certain insurance related data, it can provide document summarization, claims queries, medical and biomedical classifications, etc., relating to various insurance claims processing tasks. ChatGPT is to be understood to be based on a large language model (LLM), which is a super-sized computer program that can understand and produce natural language. It works by trying to understand a text input (e.g., a prompt) and generating dynamic text to respond. Further in accordance with the illustrated embodiments, the AI model may consist of a convolutional neural network (CNN), particularly useful when the digitized insurance data consists of one or more images (which may optically scanned images). CNNs uses deep learning algorithms to analyze and identify patterns in images and other data for performing such tasks as image recognition and processing. In accordance with the illustrated embodiments, CNNs use convolutional layers to filter inputs for useful information. The convolution operation combines input data with a convolution kernel (filter) to create a transformed feature map. The layers are arranged so that they detect simpler patterns first, like lines and curves, and more complex patterns later, like faces and objects. Further uses of CNNs in the illustrated embodiments include recognition of different objects in images by identifying certain features. For example, they can be used for providing medical diagnostics for medical insurance claims.

With the exemplary system 500 (FIG. 5) being generally shown and discussed above, description of a process (designated generally by reference numeral 600) in accordance with the illustrated embodiments will now be provided (with continuing reference to FIGS. 1-5). With reference now to FIG. 6, shown is an exemplary process 600, utilizing one or more of the aforementioned communication network 100 (FIG. 1), computing device 200 (FIG. 2), AI device 300 (FIG. 3), AI server 400 (FIG. 4) and system 500 (FIG. 5) for utilizing generative AI techniques (as described above, and below) to preferably extract, summarize, and analyze data in an insurance claims related workflow, preferably provided by an insurance claims system 103, by digitizing insurance data for subsequent AI/ML processing in generative AI systems (107), as described further below.

Starting at step 610, data associated with an insurance claim from an insurance claim system 103 is captured, via communications network 100, by the AI digitization system application 106, that is operatively coupled to at least one generative AI system 107. For instance, the data provided/captured from the insurance claim system 103 may include one or more scanned documents relating to an insurance claim, and/or may one or more photographs relating to an insurance claim. In certain illustrated embodiments, an Application Programming Interface (API) may be used for inputting the data to AI digitization system 106 from the insurance claims processing system 103. Additionally, in certain illustrated embodiments, the AI digitization system 106 is further configured and operative to reformat the captured insurance claim data in a configuration suitable for analysis for generating the one or more prompts, as described further below.

Next, at step 620 the digitization application/system 106 preferably processes the insurance data provided from insurance system 103, so as to digitize the data and preferably dynamically determine one or more prompts to be included with an Application Programming (API) call for the provided insurance data. In accordance with the illustrate embodiments, digitization, also known as digital imaging or scanning, includes converting physical records into a digital format, which may include text-based documents, photographs, maps, microfilm, analog sound, video, or film. Digitization involves encoding analog signals into binary code, which can be stored, processed, and transmitted by the AI digitization system 106. An advantage of digitizing insurance claim data captured from one or more insurance claim systems 103 includes providing data security as physical documents are susceptible to theft, damage, and loss, which can result in sensitive information being compromised. By digitizing documents and storing them in a secure, centralized repository, data relating to insurance clients are protected from potential threats.

It is to be also understood and appreciated the aforesaid one or more prompts indicate one or more AI models to be used in conjunction with the insurance claim data. It is to be further understood and appreciated that a prompt is typically a natural language request that is submitted to a generative AI system (1070) to receive a response. For instance, a prompt can contain questions, instructions, contextual information, examples, and partial input for the model to complete or continue. The type of model being used determines what the model can generate after receiving a prompt, such as text, embeddings, code, images, videos, music, and more. Additionally, it is to be understood and appreciated an API call, or API request, is a message sent from the digitization server 106 to request information or a service from a generative AI system 107. For instance, the digitization server 106 makes the request, and the generative AI system or application 107 provides a response. API calls typically transfer information to the client application for processing, or in the other direction for storage and management. As mentioned above, at step 630, the AI digitization system 106 is preferably configured and operative to digitize the provided insurance data (step 610) so as to be processed by at least one generative AI system 107.

Next, at step 640, the digitization application/system 106, provides the digitized data and associated one or more prompts, preferably via communications system 100, to at least one generative AI system 107, via the API call, such that the at least one generative AI system 107, using one or more generative AI techniques, generates AI content for the digitized data based upon the one or more prompts. For instance, the generated AI content may enable highlights to be added to one or more appropriate files associated with an insurance claim. In accordance with the illustrated embodiments, it is to be understood and appreciated the generative AI system 107 includes functionality to read and respond to the one or more prompts regarding the digitized data (e.g., scanned documents, photographs, etc.) provided by the digitization application/system 106. In accordance with other illustrated embodiments, the digitization application/system may be configured and operative to provide the digitized data and associated one or more prompts to a plurality of generative AI systems 107. It is to be understood and appreciated the generative AI systems 107 may utilize one or more Natural Language Processing (NLP) techniques and/or one generative AI system utilizes one or more Large Language Models (LLMs) techniques. It is to be further understood and appreciated the generative AI system 107 may consists of a Chat Generative Pre-Trained Transformer (ChatGPT), commonly used in a Chatbot.

Next, at step 650, upon processing the provided digitized data provided from the digitization system 106 for generating the requested AI content the digitization application, the generative AI system 107 sends the aforesaid generated AI content (step 640) content preferably to the AI digitization system 106, which in turn preferably provides it to the insurance system 103, preferably via communications network 100, for subsequent processing/analysis. It is to be understood and appreciated that the insurance system 103, in accordance with the illustrated embodiments, may be operative and configured to store the generated AI content (step 640) as a note associated with an insurance claim in the insurance claim processing system. It is additionally to be understood and appreciated that the generated AI content: includes an insurance content summarization associated with an insurance claim; includes a document summarization associated with an insurance claim; includes claims queries associated with an insurance claim; includes classification of certain information included in an insurance claim; includes medical and/or biomedical classifications; and/or includes automated summaries of the insurance data provided by the insurance claims system.

In certain embodiments, the generated AI content, after sent from the one or more generative AI systems 107 (step 650), is analyzed in the insurance claim system (which may be performed in either the insurance company system 103 and/or the AI digitization system 106) to determine information relevant to an insurance claim being processed, such as (but not limited to) how does it materially impact and/or automatically advance administration of an insurance claim being processed in the insurance claim system 103. For instance, in certain embodiments, the generated AI content is analyzed using data science technology, including, but not limited to predictive models. Other exemplary use scenarios include using the generated AI content to foster accuracy of evaluating automotive claims. For instance, the generated AI content can provide significant certainty whether or not there is an “early indicator” of a catastrophic nature in a submitted automative claim, which additionally provides improvement with compliance of Service Level Agreements (SLAs). Additional uses of the aforesaid generated AI content extent to: a) providing summarization of Call Center After-Call Work scenarios, b) generating AI content relating to digitized mailroom data; c) AI supported reporting of client claim information on portals and d) claims management relating to clients.

In accordance with additionally embodiments, the aforesaid AI digitization system 106 is integrated with a digital suite of intelligent applications, including predictive models and decision engines, such that AI can prescribe optimal workflows. Additionally, the aforesaid AI digitization system 106 may be integrated with a concierge user type application such that a user provides a query against a claim file. Still further embodiments of the aforesaid AI digitization system 106 will: generate entire claim summaries; identify risk factors on individual claims and programs; conduct audit checks; explore emerging data trends, etc. Thus, the illustrated embodiments provide a technology improvement to existing insurance claims computer processing systems through integration with AI analytical techniques for modernizing/improving insurance claims processing by automating tasks, improving accuracy, detecting fraud, enhancing customer experience, and providing valuable data insights.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of the illustrated embodiments, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

1. A computer-implemented method for generating Artificial Intelligence (AI) content for insurance claim data for processing an insurance claim in an insurance claims computer application, comprising the steps:
capturing insurance claim data, in a computer processor, from at least one data storage component, via a computer network;
analyzing, in the computer processor, the captured insurance claim data by one or more AI techniques, to generate one or more prompts, wherein the one or more prompts are dynamically generated based on the analysis of the captured insurance claim data to select appropriate AI models from a plurality of available AI models for processing the specific type of insurance claim data captured, and wherein the one or more prompts indicate one or more AI models to be used in conjunction with captured insurance claim data;
digitizing, in the computer processor, the captured insurance claim data so as to be processed by at least one generative AI system;
providing, from the computer processor, the digitized insurance claims data and associated one or more prompts to the at least one generative AI system, via an application programming interface (API) call, to cause the at least one generative AI system, using the one or more AI models, to generate AI content responsive to the generated one or more prompts and associated captured insurance claims data, wherein the generated AI content consists of one or more of: an insurance content summarization, a document summarization, claims queries, and classification of medical or biomedical information, each associated with the insurance claim; and
providing, from the computer processor, the generated AI content to the insurance claim computer application, wherein the generated AI content causes the insurance claims computer application to automatically advance administration of the insurance claim.

2. The computer-implemented method as recited in claim 1, wherein the generated AI content is stored in a computer data storage component associated with the insurance claim computer application.

3. (canceled)

4. (canceled)

5. The computer-implemented method as recited in claim 1, wherein the captured insurance claim data includes data associated with one or more scanned documents relating to an insurance claim.

6. The computer-implemented method as recited in claim 5, when the one or more AI models include a convolutional neural network.

7. The computer-implemented method as recited in claim 1, wherein the prompts generated responsive to analysis of the captured insurance claim data are dynamically determined by the insurance claims computer application.

8. The computer-implemented method as recited in claim 7, wherein the at least one generative AI system utilizes one or more Natural Language Processing (NLP) techniques.

9. (canceled)

10. The computer-implemented method as recited in claim 1, further including the step, reformatting, by the computer processor, the captured insurance claim data in a configuration suitable for analysis for generating the one or more prompts.

11. A computer-implemented system for generating Artificial Intelligence (AI) content for insurance claim data for processing an insurance claim in an insurance claims computer application, comprising:
a memory configured to store instructions;
a processor disposed in communication with said memory, wherein said processor upon execution of the instructions is configured to:
capture insurance claim data from at least one data storage component, via a computer network;
analyze the captured insurance claim data by one or more AI techniques, to generate one or more prompts, wherein the one or more prompts are dynamically generated based on the analysis of the captured insurance claim data to select appropriate AI models from a plurality of available AI models for processing the specific type of insurance claim data captured, and wherein the one or more prompts indicate one or more AI models to be used in conjunction with captured insurance claim data;
digitize the captured insurance claim data so as to be processed by at least one generative AI system;
provide the digitized insurance claims data and associated one or more prompts to the at least one generative AI system, via an application programming interface (API) call, to cause the at least one generative AI system, using the one or more AI models, to generate AI content responsive to the generated one or more prompts and associated captured insurance claims data, wherein the generated AI content consists of one or more of: an insurance content summarization, a document summarization, claims queries, and classification of medical or biomedical information, each associated with the insurance claim; and
provide the generated AI content to the insurance claim computer application, wherein the generated AI content causes the insurance claims computer application to automatically advance administration of the insurance claim.

12. The computer system as recited in claim 11, wherein the generated AI content is stored in a computer data storage component associated with the insurance claim computer application.

13. (canceled)

14. (canceled)

15. The computer system as recited in claim 11, wherein the captured insurance claim data includes data associated with one or more scanned documents relating to an insurance claim.

16. The computer system as recited in claim 15, when the one or more AI models include a convolutional neural network.

17. The computer system as recited in claim 11, wherein the prompts generated responsive to analysis of the captured insurance claim data are dynamically determined by the insurance claims computer application.

18. The computer system as recited in claim 17, wherein the at least one generative AI system utilizes one or more Natural Language Processing (NLP) techniques.

19. (canceled)

20. The computer system as recited in claim 11, wherein the processor is further configured to reformat the captured insurance claim data in a configuration suitable for analysis for generating the one or more prompts.
